(19) United States
(12) Patent Application Publication
(10) Pub. No.: US 2026/0186994 A1
(43) Pub. Date: Jul. 2, 2026

(54) OPERATION METHOD OF STORAGE CONTROLLER CONFIGURED TO CONTROL NONVOLATILE MEMORY DEVICE

(71) Applicant: SAMSUNG ELECTRONICS CO., LTD., Suwon-si (KR)

(72) Inventors: Junho JANG, Suwon-si (KR); WOOSEONG CHEONG, Suwon-si (KR)

(73) Assignee: SAMSUNG ELECTRONICS CO., LTD., Suwon-si (KR)

(21) Appl. No.: 19/268,149

(22) Filed: Jul. 14, 2025

(30) Foreign Application Priority Data
Jan. 2, 2025 (KR) 10-2025-0000464

(51) Int. Cl. G06F 13/28

(52) U.S. Cl. CPC G06F 13/28; G06F 2213/28

(57) ABSTRACT

An operation method of a storage device including a nonvolatile memory device and a buffer memory device, including: receiving a force unit access (FUA) command from an external host device; and performing a direct memory access (DMA) operation based on a status of the storage device in response to the FUA command, wherein the DMA operation comprises one of a first DMA operation and a second DMA operation, wherein the first DMA operation comprises transferring data from the external host device to the nonvolatile memory device without using the buffer memory device, and wherein the second DMA operation comprises transferring the data from the external host device to the buffer memory device.

### CROSS-REFERENCE TO RELATED APPLICATIONS

This application is based on and claims priority under 35 U.S.C. § 119 to Korean Patent Application No. 10-2025-0000464, filed on Jan. 2, 2025, in the Korean Intellectual Property Office, the disclosure of which is incorporated by reference herein in its entirety.

### BACKGROUND

The present disclosure described relates to a semiconductor memory, and more particularly, to an operating method of a storage controller configured to control a nonvolatile memory device.

A semiconductor memory may be classified as a volatile memory device, in which stored data disappear when a power supply is deactivated or turned off(e.g., a static random access memory (SRAM) or a dynamic random access memory (DRAM)), or as a nonvolatile memory device, in which stored data are retained even when a power supply is deactivated or turned off (e.g., a flash memory device, a phase-change RAM (PRAM), a magnetic RAM (MRAM), a resistive RAM (RRAM), or a ferroelectric RAM (FRAM)).

A force unit access (FUA) command may refer to a command that allows a host device to bypass a data cache and to store data in a nonvolatile memory device when the host device stores the data. When receiving the FUA command, a controller of the nonvolatile memory device may temporarily store data in a buffer of a storage device, and then store the data in the nonvolatile memory device. In this case, power consumption may occur during a process of storing data in a buffer of a storage device.

### SUMMARY

Provided is a storage controller configured to control a nonvolatile memory device having improved reliability and improved performance.

Additional aspects will be set forth in part in the description which follows and, in part, will be apparent from the description, or may be learned by practice of the presented embodiments.

In accordance with an aspect of the disclosure, an operation method of a storage device including a nonvolatile memory device and a buffer memory device includes: receiving a force unit access (FUA) command from an external host device; and performing a direct memory access (DMA) operation based on a status of the storage device in response to the FUA command, wherein the DMA operation comprises one of a first DMA operation and a second DMA operation, wherein the first DMA operation comprises transferring data from the external host device to the nonvolatile memory device without using the buffer memory device, and wherein the second DMA operation comprises transferring the data from the external host device to the buffer memory device.

In accordance with an aspect of the disclosure, a storage device includes: a buffer memory device; a nonvolatile memory device configured to store data received from an external host device; and a storage controller comprising a one-time direct memory access (DMA) manager, wherein the storage controller is configured to: receive a force unit access (FUA) command from the external host device; and perform a DMA operation based on a status of the storage device in response to the FUA command, wherein the DMA operation comprises one of a first DMA operation and a second DMA operation, wherein the first DMA operation comprises transferring the data from the external host device to the nonvolatile memory device without using the buffer memory device, and wherein the second DMA operation comprises transferring the data from the external host device to the buffer memory device.

In accordance with an aspect of the disclosure, a storage system includes: a storage device comprising a storage controller, wherein the storage controller comprises a one-time direct memory access (DMA) manager, a buffer memory device, and a nonvolatile memory device; and a host device, wherein the host device is configured to: transfer a force unit access (FUA) command to the storage device, wherein the storage device is further configured to: perform a DMA operation based on a status of the storage device in response to the FUA command, wherein the DMA operation comprises one of a first DMA operation and a second DMA operation, wherein the first DMA operation comprises transferring data from the host device to the nonvolatile memory device without using the buffer memory device, and wherein the second DMA operation comprises transferring the data from the host device to the buffer memory device.

### BRIEF DESCRIPTION OF THE FIGURES

The above and other objects, features, and advantages of certain embodiments of the present disclosure will be more apparent by from the following description taken in conjunction with the accompanying drawings, in which:

FIG. 1 is a block diagram illustrating a storage system, according to an embodiment;

FIG. 2 is a block diagram illustrating a storage controller of FIG. 1, according to an embodiment;

FIG. 3 is a drawing showing the host device of FIG. 1, according to an embodiment;

FIG. 4 is a flowchart for describing an operation in which the storage controller of FIG. 1 determines whether a write command is a FUA command, according to an embodiment;

FIG. 5 is a flowchart for describing an operation of the one-time DMA manager of FIG. 1 to check the status of the storage device, according to an embodiment;

FIG. 6 is a flowchart for describing an operation of the storage system of FIG. 1, according to an embodiment;

FIGS. 7A, 7B, and 7C are drawings for describing an operation of the storage system of FIG. 1, according to an embodiment;

FIG. 8 is a drawing showing a data center to which a storage device is applied, according to an embodiment;

### DETAILED DESCRIPTION

Hereinafter, embodiments of the present disclosure may be described in detail and clearly to such an extent that an ordinary one in the art may more easily implement the present disclosure.

As used herein, expressions such as “at least one of,” when preceding a list of elements, modify the entire list of elements and do not modify the individual elements of the list. For example, the expression, “at least one of A, B, and C,” should be understood as including only A, only B, only C, both A and B, both A and C, both B and C, or all of A, B, and C.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

As used herein, when an action or operation is referred to as occurring “in response to” an event or occurrence, this may mean that action or operation occurs directly or indirectly in response to or based on the event or occurrence.

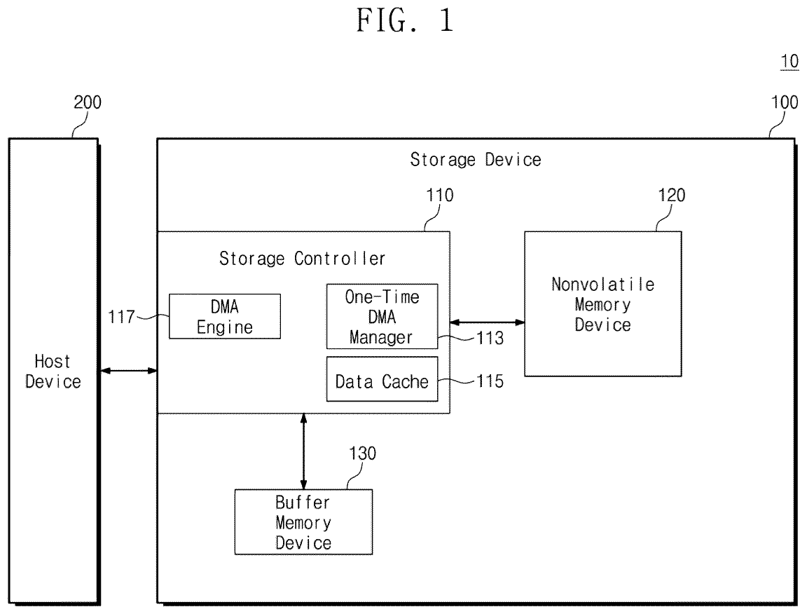

FIG. 1 is a block diagram illustrating a storage system, according to an embodiment of the present disclosure. Referring to FIG. 1, a storage system 10 may include a storage device 100 and a host device 200. In an embodiment, the storage system 10 may be, or be included in, a computing system or an information processing system, such as a computer, a notebook, a server, a workstation, a mobile phone, a personal digital assistant (PDA), a portable multimedia player (PMP), a smartphone, or a wearable device.

The host device 200 may access the storage device 100. For example, according to a predetermined interface (e.g., at least one of a predetermined communication protocol, a predetermined communication standard, a predetermined interface protocol, and predetermined interface scheme), the host device 200 may store data in the storage device 100 or may read out data stored in the storage device 100. In an embodiment, the predetermined interface may be a Nonvolatile Memory express (NVMe) interface, but the scope of the present disclosure is not limited thereto. In an embodiment, the predetermined interface may include at least one of various interfaces (e.g., various interface protocols and interface schemes) such as an Advanced Technology Attachment (ATA) interface, a Serial ATA (SATA) interface, an external SATA (e-SATA) interface, a Small Computer Small Interface (SCSI) interface, a Serial Attached SCSI (SAS) interface, a Peripheral Component Interconnection (PCI) interface, a PCI express (PCIe) interface, a NVM express (NVMe) interface, an IEEE 1394 interface, a Universal Serial Bus (USB) interface, a Secure Digital (SD) card interface, a Multi-Media Card (MMC) interface, an embedded Multi-Media Card (eMMC) interface, a Universal Flash Storage (UFS) interface, an embedded Universal Flash Storage (eUFS) interface, a Compact Flash (CF) card interface, and a Compute eXpress Link (CXL) interface.

The storage device 100 may operate under the control of the host device 200. For example, under the control of the host device 200, the storage device 100 may store data and may output the stored data. In an embodiment, the storage device 100 may be a mass storage device configured to store data in a computing system, such as a Solid State Drive (SSD), a Universal Flash Storage (UFS) card, or the like, but the scope of the present disclosure is not limited thereto. For example, the storage device 100 may be a mass storage medium included in a mobile system such as a mobile phone, a smart phone, a tablet personal computer, a wearable device, a healthcare device, or an Internet Of Things (IoT) device. In some embodiments, the storage device 100 may be a mass storage medium included in a personal computer, a laptop computer, a server, a media player, or an automotive device such as a navigation device.

In an embodiment, the storage device 100 may include a storage controller 110, a nonvolatile memory device 120, and a buffer memory device 130.

The storage controller 110 may control the nonvolatile memory device 120 under the control of the host device 200. For example, under the control of the host device 200, the storage controller 110 may store data in the nonvolatile memory device 120 and may read data stored in the nonvolatile memory device 120.

The nonvolatile memory device 120 may operate under the control of the storage controller 110. For example, under the control of the storage controller 110, the nonvolatile memory device 120 may store data and may output the stored data. In an embodiment, the nonvolatile memory device 120 may be a flash memory device. However, the scope of the present disclosure is not limited thereto.

The buffer memory device 130 may temporarily store data. For example, the buffer memory device 130 may temporarily store data before storing the data in the nonvolatile memory device 120.

In an embodiment, the storage controller 110 may include a one-time direct memory access (DMA) manager 113, a data cache 115, and a DMA engine 117.

The DMA engine 117 may be configured to control DMA operations between the buffer memory device 130 and the host device 200. In some embodiments, the DMA engine 117 may be configured to control DMA operations between the nonvolatile memory device 120 and the buffer memory device 130. According to an embodiment of the present disclosure, the DMA engine 117 may be configured to control DMA operations between the host device 200 and the nonvolatile memory device 120. For example, while the DMA engine 117 controls the DMA operations between the host device 200 and the nonvolatile memory device 120, data may be stored directly from the host device 200 to the nonvolatile memory device 120.

For example, the storage device 100 may operate in a DMA mode to improve a data transfer rate. The DMA mode may refer to an operating mode in which data is delivered under the control of the DMA engine 117, with or without the intervention of a processor or core included in the storage controller 110. For example, because there may be no need for control or processing from the processor or the core while data are delivered, the data transfer rate may be improved. In this DMA operating mode, the DMA engine 117 may control or manage the transfer of data between the host device 200 and the buffer memory device 130, and may control or manage the transfer of data between the nonvolatile memory device 120 and the buffer memory device 130. According to an embodiment of the present disclosure, the DMA engine 117 may control or manage data transfer between the host device 200 and the nonvolatile memory device 120. For example, as the DMA engine 117 controls the DMA operations between the host device 200 and the nonvolatile memory device 120, data may be stored directly from the host device 200 to the nonvolatile memory device 120.

In an embodiment, the host device 200 may transmit a write command for writing data to the storage device 100 operating in the DMA mode. When the storage controller 110 receives a write command from the host device 200, the DMA engine 117 may be configured to store write data (e.g., data corresponding to an address included in the write command) in the buffer memory device 130 without the control of the processor or the core (e.g., without receiving a specific command from the processor or the core). After the write data is stored in the buffer memory device 130, the DMA engine 117 may be configured to write the write data stored in the buffer memory device 130 to the nonvolatile memory device 120 without the control of the processor or the core (e.g., without receiving a specific command from the processor or the core). According to an embodiment of the present disclosure, the DMA engine 117 may be configured to store the write data directly from the host device 200 to the nonvolatile memory device 120 without the control of the processor or the core (e.g., without receiving a specific command from the processor or the core).

In an embodiment, as in a general write command, the storage device 100 may store data corresponding to the address included in the write command in the data cache 115 of the storage controller 110. Afterwards, based on the data cache 115 being full, the storage device 100 may store the data stored in the data cache 115 in the nonvolatile memory device 120.

In an embodiment, a FUA command may be a type of write command. The FUA command may be a command for ensuring the integrity or reliability of data. For example, when the storage device 100 stores data in the nonvolatile memory device 120 based on the FUA command, the FUA command may be a command for ensuring the integrity or reliability of the data stored in the nonvolatile memory device 120. When receiving the FUA command, the storage device 100 may store the data corresponding to the address included in the FUA command in the nonvolatile memory device 120 by bypassing the data cache 115 of the storage controller 110. For example, unlike a general write command, the data cache 115 of the storage controller 110 may not be used for the FUA command.

For example, when receiving the FUA command, a storage device according to a comparative example may temporarily store the data corresponding to the address included in the FUA command in a buffer memory device. Afterwards, the storage device may store data temporarily stored in the buffer memory device to a nonvolatile memory device. In this case, power may be additionally lost as the data corresponding to the address included in the FUA command is temporarily stored in the buffer memory device.

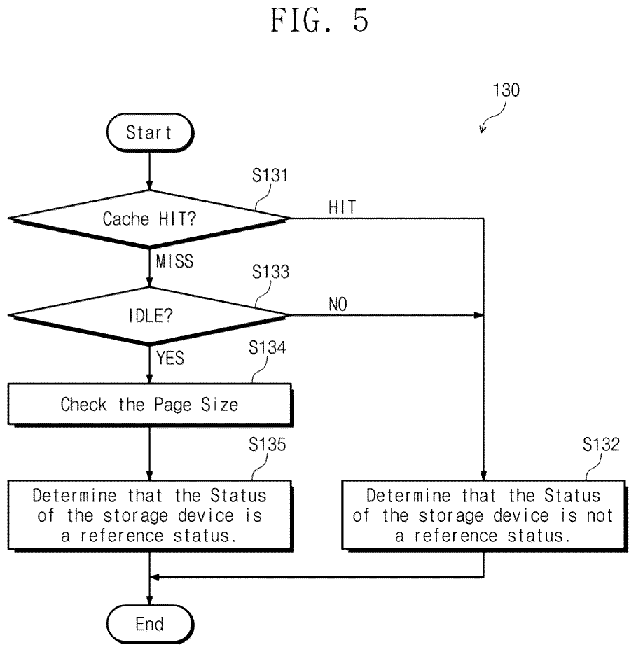

However, according to an embodiment of the present disclosure, when the FUA command is received, the one-time DMA manager 113 of the storage controller 110 may check the status of the storage device 100. For example, the one-time DMA manager 113 may determine whether the status of the storage device 100 is a reference status. Based on the status of the storage device 100 being determine to be the reference status, the storage device 100 may perform a first DMA operation. The first DMA operation may include transmitting data from the host device 200 to the nonvolatile memory device 120 without using (e.g., going through) the buffer memory device 130. While performing the first DMA operation, the storage device 100 may not store data in the buffer memory device 130, thereby preventing additional power loss. Based on the status of the storage device 100 being determined to be a status that is not the reference status, the storage device 100 may perform a second DMA operation. The second DMA operation may include storing data from the host device 200 to the buffer memory device 130, and then storing the data from the buffer memory device 130 to the nonvolatile memory device 120. The storage device 100 may temporarily store the data in the buffer memory device 130 according to the second DMA operation, and thus additional power loss may occur. An example of determining whether the status of the storage device 100 is the reference status is described below with reference to FIG. 5.

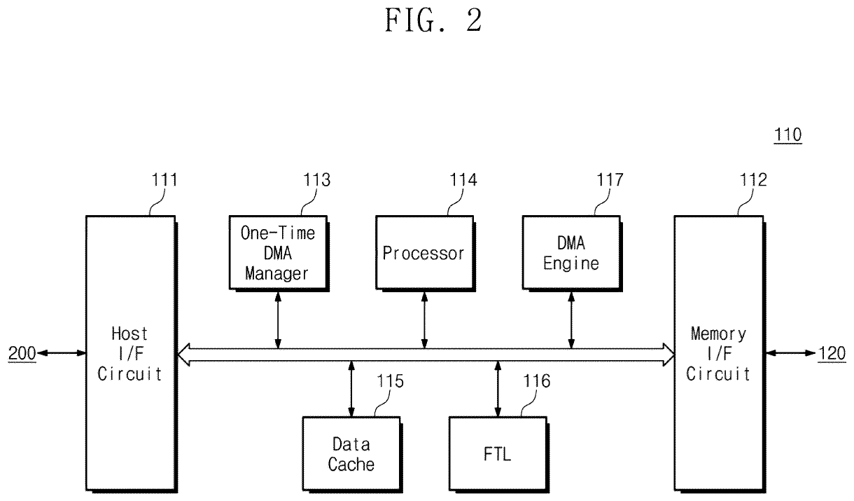

FIG. 2 is a block diagram illustrating a storage controller of FIG. 1. Referring to FIGS. 1 and 2, the storage controller 110 may include a host interface circuit 111, a memory interface circuit 112, the one-time DMA manager 113, a processor 114, the data cache 115, a FTL 116, and the DMA engine 117.

The host interface circuit 111 may communicate with the host device 200. In an embodiment, the host interface circuit 111 may be configured to comply with (e.g., operate in accordance with or according to) the predetermined interface, the predetermined communication protocol, or the predetermined communication standard between the host device 200 and the storage device 100. In an embodiment, the host interface circuit 111 may be configured to comply with the Nonvolatile Memory express (NVMe) standard. However, the scope of the present disclosure is not limited thereto.

The memory interface circuit 112 may communicate with the nonvolatile memory device 120. For example, the memory interface circuit 112 may access or control the nonvolatile memory device 120. For example, the memory interface circuit 112 may control the nonvolatile memory device 120 to read data stored in the nonvolatile memory device 120 and to write data to the nonvolatile memory device 120. In an embodiment, the memory interface circuit 112 may include a flash controller configured to control the nonvolatile memory device 120. In an embodiment, the memory interface circuit 112 may be configured to comply with the predetermined interface, the predetermined communication protocol, or the predetermined communication standard. The predetermined interface, the predetermined communication protocol, or the predetermined communication standard may be a standard protocol such as Toggle or Open NAND Flash Interface (ONFI), but the scope of the present disclosure is not limited thereto.

The one-time DMA manager 113 may check the status of the storage device 100 based on a FUA command. For example, the one-time DMA manager 113 may check the status of the storage device 100 to determine whether to perform a first DMA operation or a second DMA operation. Based on determining that the storage device 100 is in a reference status, the storage device 100 may perform the first DMA operation. For example, while performing the first DMA operation, the storage device 100 may transmit data from the host device 200 to the nonvolatile memory device 120 without going through the buffer memory device 130. Based on determining that the status of the storage device 100 is not the reference status, the storage device 100 may perform the second DMA operation. For example, while performing the second DMA operation, the storage device 100 may store data from the host device 200 to the buffer memory device 130, and then may store data from the buffer memory device 130 to the nonvolatile memory device 120. An example of the operation in which the one-time DMA manager 113 checks a status of the storage device 100 is described below with reference to FIG. 5.

The processor 114 may control overall operations of the storage controller 110. For example, the processor 114 may launch various applications running on the storage controller 110.

The data cache 115 may store data. For example, when performing a read operation, the storage system 10 may store frequently accessed data. As another example, when the storage system 10 performs a write operation, the data cache 115 may store data from the host device 200, and then the storage system 10 may store the data in the nonvolatile memory device 120 based on the data cache 115 being full.

The FTL 116 may perform a maintenance task for efficiently managing or using the nonvolatile memory device 120. In an embodiment, the maintenance task may include an address mapping operation, a wear-leveling operation, a garbage collection operation, or the like.

The address mapping operation may include changing a logical block address (LBA) received from the host device 200 into a physical block address (PBA). For example, the LBA may be an address used for the host device 200 to request data, and the PBA may be the address used to actually store the data in the nonvolatile memory device 120.

The DMA engine 117 may be configured to control DMA operations between the buffer memory device 130 and the host device 200. The DMA engine 117 may be configured to control DMA operations between the nonvolatile memory device 120 and the buffer memory device 130.

According to an embodiment of the present disclosure, the one-time DMA manager 113 may determine whether data corresponding to the LBA requested by the host device 200 is present in the buffer memory device 130. When the data corresponding to the LBA requested by the host device 200 is present in the buffer memory device 130, the one-time DMA manager 113 may determine that a cache hit has occurred (e.g., may detect a cache hit). When the data corresponding to the LBA requested by the host device 200 is not present in the buffer memory device 130, the one-time DMA manager 113 may determine that a cache miss has occurred (e.g., may detect a cache miss). In an embodiment, if the one-time DMA manager 113 detects a cache hit, a data hazard may occur when the storage device 100 performs the first DMA operation. Because the data corresponding to the LBA requested by the host device 200 is present in the buffer memory device 130, the data hazard may occur. The data hazard may cause performance degradation of a write operation. Accordingly, the one-time DMA manager 113 may detect a cache hit or a cache miss to determine whether the storage device 100 should perform the first DMA operation.

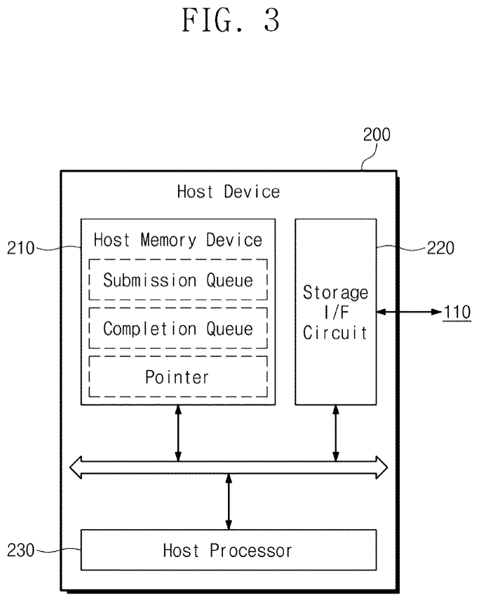

FIG. 3 is a drawing showing the host device of FIG. 1. Referring to FIGS. 1 and 3, the host device 200 may include a host memory device 210, a storage interface circuit 220 (illustrated as “Storage I/F Circuit”), and a host processor 230.

In an embodiment, the host device 200 may generate a command. For example, the host device 200 may generate at least one of a write command and a read command. For example, the host device 200 may generate the write command or the read command in a submission queue of the host memory device 210. The submission queue may be a circular buffer in which commands are stored before the command is executed after the host device 200 generates the command.

In an embodiment, when a command is executed, a completion for providing a notification of the status of the executed command may be stored in a completion queue of the host memory device 210. In some embodiments, the submission queue and the completion queue may be a single set, but embodiments are not limited thereto. For example, in some embodiments, there may be a plurality of submission queues, and there may be a plurality of completion queues. The submission queue may store a plurality of commands. The completion queue may store a plurality of completions, each of which may indicate that a command has completely executed.

In an embodiment, based on the command generated in the submission queue being a write command, data to be transmitted and a pointer including address information where the data to be transmitted is stored may be loaded onto the host memory device 210.

In an embodiment, based on the command generated in the submission queue being a read command, data to be read and a pointer including address information where the data to be read is stored may be loaded onto the host memory device 210. In an embodiment, there may be a plurality of pointers.

The storage interface circuit 220 may provide a physical connection through which the host device 200 and the storage device 100 may interface with each other. The storage interface circuit 220 may transmit, to the storage device 100, at least one of commands, addresses, and data generated based on various requests. The interfacing method of the storage interface circuit 220 may be NVMe based on PCI express (PCIe). However, the storage interface circuit 220 is not limited thereto. The storage interface circuit 220 may be a type of interface for transmitting and receiving data by fetching a command generated by the host memory device 210 and fetching a pointer indicating a physical address on the host memory device 210 corresponding to the generated command.

The host processor 230 may execute software (e.g., at least one of applications, operating systems, device drivers, and the like) running on the host device 200. For example, the host processor 230 may launch an operating system (OS) and an application program loaded onto the host memory device 210. The host processor 230 may allow the storage device 100 to store program data, and may allow the host memory device 210 to store data read from the storage device 100. The host memory device 210 may include a plurality of host processors 230.

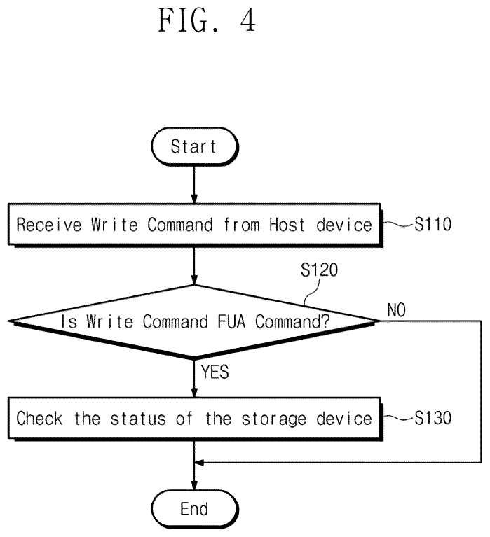

FIG. 4 is a flowchart for describing an operation in which the storage controller of FIG. 1 determines whether a write command is a FUA command.

Referring to FIGS. 1, 2, and 4, at operation S110, the storage controller 110 may receive a write command from the host device 200. The write command may be a command for storing data in the nonvolatile memory device 120 of the storage device 100.

At operation S120, the storage controller 110 may determine whether the received write command is a FUA command. The FUA command may be a type of write command. According to the FUA command, the storage device 100 may store data corresponding to an address included in the FUA command in the nonvolatile memory device 120 instead of storing the data in the data cache 115 of the storage controller 110.

Based on determining that the write command is the FUA command (YES at operation S120), at operation S130, the storage controller 110 may check the status of the storage device 100. For example, the one-time DMA manager 113 of the storage controller 110 may determine whether the status of the storage device 100 is a reference status. For example, in order for the storage device 100 to determine whether to perform the first DMA operation or the second DMA operation, the one-time DMA manager 113 of the storage controller 110 may check the status of the storage device 100.

Based on determining that the write command is not a FUA command (NO at operation S120), the storage controller 110 may perform subsequent operations without checking the status of the storage device 100.

FIG. 5 is a flowchart for describing an operation of the one-time DMA manager of FIG. 1 to check the status of the storage device. Referring to FIGS. 1 to 5, at operation S131, the one-time DMA manager 113 of the storage controller 110 may detect a cache hit or a cache miss (e.g., may determine whether a cache hit or a cache miss has occurred). Based on determining that the data corresponding to the LBA requested by the host device 200 is present in the buffer memory device 130, the one-time DMA manager 113 may detect the cache hit. Based on determining that the data corresponding to the LBA requested by the host device 200 is not present in the buffer memory device 130, the one-time DMA manager 113 may detect the cache miss. In an embodiment, based on the one-time DMA manager 113 detecting the cache hit, the data hazard may occur. When the data corresponding to the LBA requested by the host device 200 is present in the buffer memory device 130, the data hazard may occur. The data hazard may cause performance degradation of a write operation. Accordingly, the one-time DMA manager 113 may detect the cache hit or the cache miss to prevent the data hazard.

Based on the one-time DMA manager 113 detecting a cache hit (HIT at operation S131), at operation S132, the one-time DMA manager 113 may determine that the status of the storage device 100 is not a reference status. Based on determining that the status of the storage device 100 is not the reference status, the storage device 100 may perform a second DMA operation. While performing the second DMA operation, the storage device 100 may store data from the host device 200 to the buffer memory device 130, and then may store data from the buffer memory device 130 to the nonvolatile memory device 120. In this case, power may be additionally lost by storing data in the buffer memory device 130.

Based on the one-time DMA manager 113 detecting a cache miss (MISS at operation S131), at operation S133, the one-time DMA manager 113 may determine whether the storage device 100 is in a busy status or an idle status. For example, as illustrated in FIG. 5, operation 133 may include determining whether the status of the storage device 100 an idle status IDLE. The busy status may be a status in which the storage device 100 is currently performing a task. The idle status may be a status in which the storage device 100 is not currently performing any work. In this case, to determine whether the storage device 100 is in a reference status or not, the one-time DMA manager 113 may determine whether the storage device 100 is in the busy status or the idle status.

Based on determining that the storage device 100 is in the busy status (NO at operation S133), at operation S132, the one-time DMA manager 113 may determine that the status of the storage device 100 is not the reference status. Based on determining that the status of the storage device 100 is not the reference status, the storage device 100 may perform a second DMA operation. While performing the second DMA operation, the storage device 100 may store data from the host device 200 to the buffer memory device 130, and then may store data from the buffer memory device 130 to the nonvolatile memory device 120. In this case, power may be additionally lost by storing data in the buffer memory device 130.

Based on determining that the storage device 100 is in the idle status (YES at operation S133), at operation S134, the one-time DMA manager 113 may check the size of the data. For example, the one-time DMA manager 113 may compare the size of the data to be written with a page size. For example, because a data write unit of the storage device 100 may be written in a page unit (e.g., because the write data may be written in units of pages, for example one page at a time), the one-time DMA manager 113 may compare the size of the data to be written with the page size. For example, based on determining that the size of the data to be written is smaller than the page size, the one-time DMA manager 113 may temporarily store the data in the data cache 115 of the storage controller 110 until the size of the data to be written is greater than the page size. Based on the data temporarily stored in the data cache 115 being greater than or equal to the page size according to a temporary storage operation, the data may be stored in the nonvolatile memory device 120. However, based on the size of the data to be written being greater than or equal to the page size, the storage device 100 may not temporarily store the data to be written in the data cache 115 of the storage controller 110.

At operation S135, the one-time DMA manager 113 may determine that the status of the storage device is the reference status. Based on determining that the status of the storage device 100 is the reference status, the storage device 100 may perform a first DMA operation. While performing the first DMA operation, the storage device 100 may store data from the host device 200 to the nonvolatile memory device 120 without using (e.g. going through) the buffer memory device 130. In this case, the data may be not stored in the buffer memory device 130, preventing additional power loss.

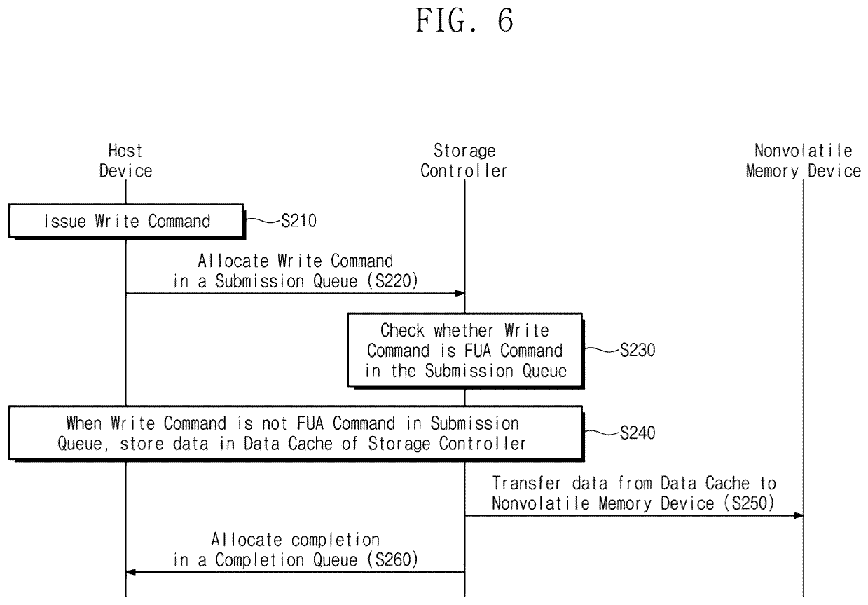

FIG. 6 is a flowchart for describing an operation of the storage system of FIG. 1. Referring to FIGS. 1 to 6, in operation S210, the host device 200 may issue a write command. For example, the host device 200 may issue the write command for writing data to the nonvolatile memory device 120 of the storage device 100.

At operation S220, the host device 200 may allocate the write command to a submission queue. The host device 200 may update a doorbell register after allocating the write command to the submission queue. The storage device 100 may determine that the write command has been allocated to the submission queue, based on the updated doorbell register.

At operation S230, the storage device 100 may determine whether the write command in the submission queue is a FUA command. For example, to determine whether to use the data cache 115 of the storage controller 110, the storage device 100 may determine whether the write command in the submission queue is the FUA command.

At operation S240, based on determining that the write command in the submission queue is not the FUA command, the host device 200 may store the data in the data cache 115 of the storage controller 110. At operation S250, the storage controller 110 may store data related to the write command stored in the data cache 115 to the nonvolatile memory device 120. For example, the storage controller 110 may store the data stored in the data cache 115 in the nonvolatile memory device 120 after scheduling the data based on a write priority or a resource availability status.

At operation S260, the storage controller 110 may allocate a completion to a completion queue of the host device 200. For example, the storage controller 110 may allocate, to the completion queue of the host device 200, the completion indicating the result of executing the write command.

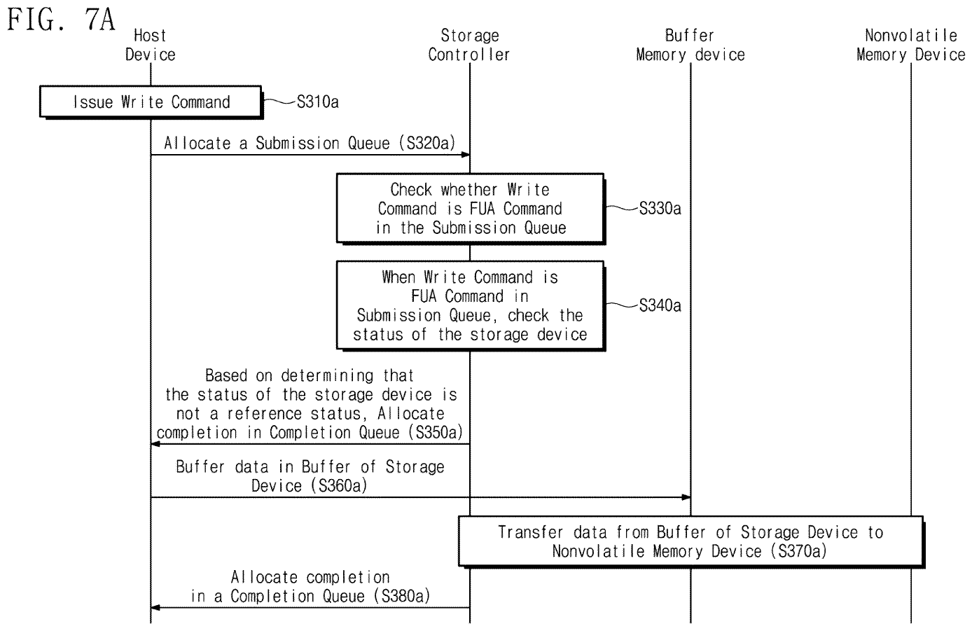

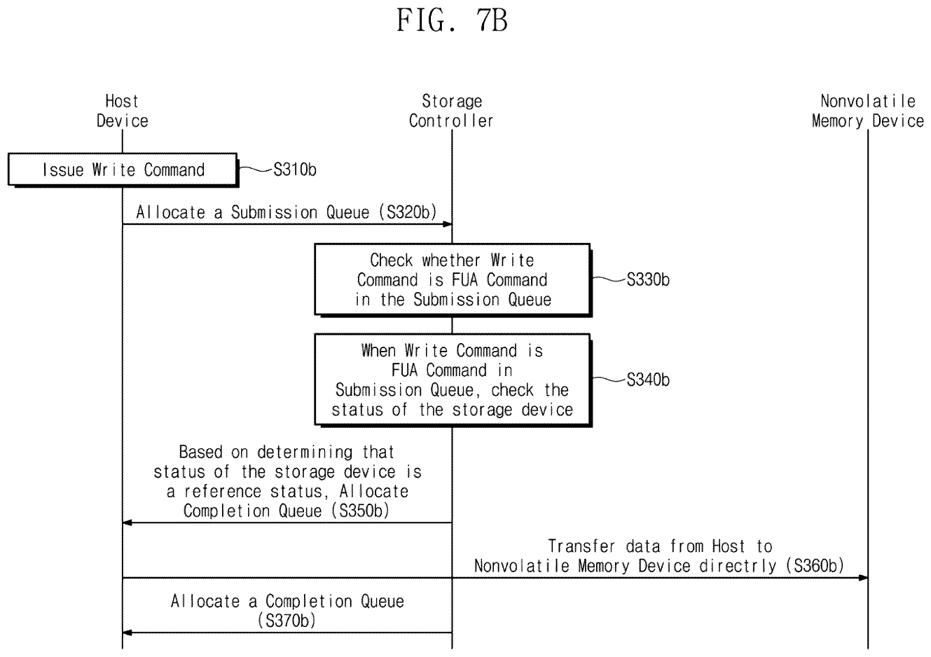

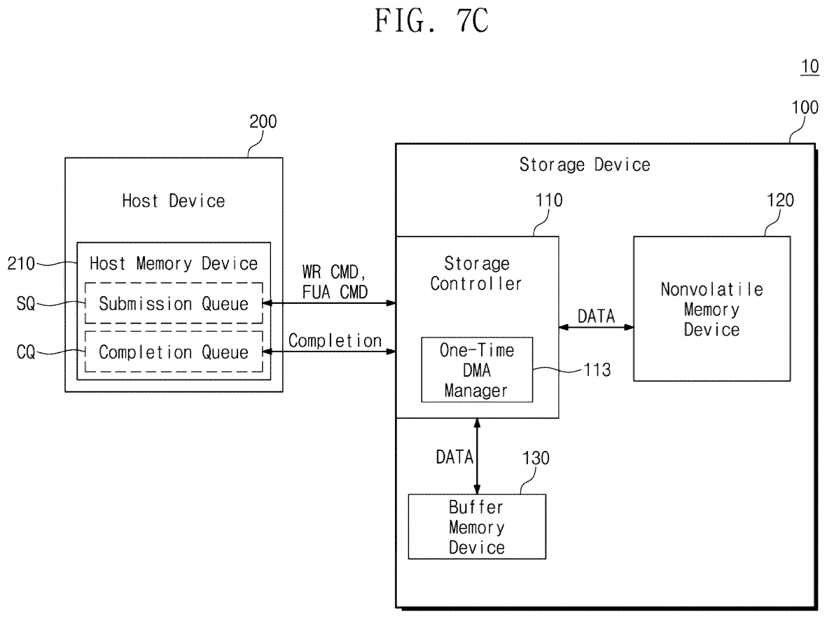

FIGS. 7A, 7B, and 7C are drawings for describing an operation of the storage system of FIG. 1. Referring to FIGS. 1 to 7A and 7C, at operation S310a, the host device 200 may issue a write command WR CMD. At operation S320a, the host device 200 may allocate the write command WR CMD to a submission queue SQ. At operation S330a, the storage device 100 may determine whether the write command WR CMD in the submission queue SQ is a FUA command FUA CMD.

In operation S340a, based on determining that the write command WR CMD in the submission queue SQ is the FUA command FUA CMD, the storage controller 110 may check the status of the storage device 100. For example, to determine whether to perform the first DMA operation or the second DMA operation, the one-time DMA manager 113 of the storage controller 110 may check the status of the storage device 100.

At operation S350a, based on determining that the status of the storage device 100 is not a reference status, the storage device 100 may allocate, to a completion queue CQ, a completion indicating that the storage device 100 is not in the reference status. The host device 200 may check that the storage device 100 is not in the reference status, by checking the completion queue CQ.

At operation S360a, the host device 200 may temporarily store data DATA in the buffer memory device 130 of the storage device 100 by a second DMA operation. At operation S370a, according to the second DMA operation, the storage controller 110 may store the data DATA stored in the buffer memory device 130 of the storage device 100 to the nonvolatile memory device 120. In this case, power may be additionally lost by storing the data DATA in the buffer memory device 130 of the storage device 100.

At operation S380a, the storage controller 110 may allocate a completion to the completion queue CQ of the host device 200. For example, the storage controller 110 may allocate, to the completion queue CQ of the host device 200, the completion indicating that the data DATA corresponding to an address included in the FUA command FUA CMD has been stored in the nonvolatile memory device 120.

Next, referring to FIGS. 1 to 6, 7B, and 7C, at operation S310b, the host device 200 may issue the write command WR CMD. At operation S320b, the host device 200 may allocate the write command WR CMD to the submission queue SQ. At operation S330b, the storage device 100 may determine whether the write command WR CMD in the submission queue SQ is the FUA command FUA CMD.

In operation S340b, based on determining that the write command WR CMD in the submission queue SQ is the FUA command FUA CMD, the storage controller 110 may check the status of the storage device 100. For example, to determine whether to perform the first DMA operation or the second DMA operation, the one-time DMA manager 113 of the storage controller 110 may check the status of the storage device 100.

At operation S350b, based on determining that the status of the storage device 100 is the reference status, the storage controller 110 may allocate, to the completion queue CQ, a completion indicating that the status of the storage device 100 is the reference status. The host device 200 may check that the status of the storage device 100 is the reference status, by checking the completion queue CQ.

At operation S360b, the host device 200 may directly store the data DATA from the host device 200 to the nonvolatile memory device 120. For example, according to a first DMA operation, the host device 200 may directly store the data DATA corresponding to the address included in the FUA command FUA CMD in the nonvolatile memory device 120, instead of temporarily storing the data DATA in the buffer memory device 130 of the storage device 100. In this case, additional power loss may be reduced by not storing the data DATA in the buffer memory device 130.

At operation S370b, the storage controller 110 may allocate a completion to the completion queue CQ of the host device 200. For example, the storage controller 110 may allocate, to the completion queue CQ of the host device 200, the completion indicating that the data DATA corresponding to an address included in the FUA command FUA CMD has been stored in the nonvolatile memory device 120.

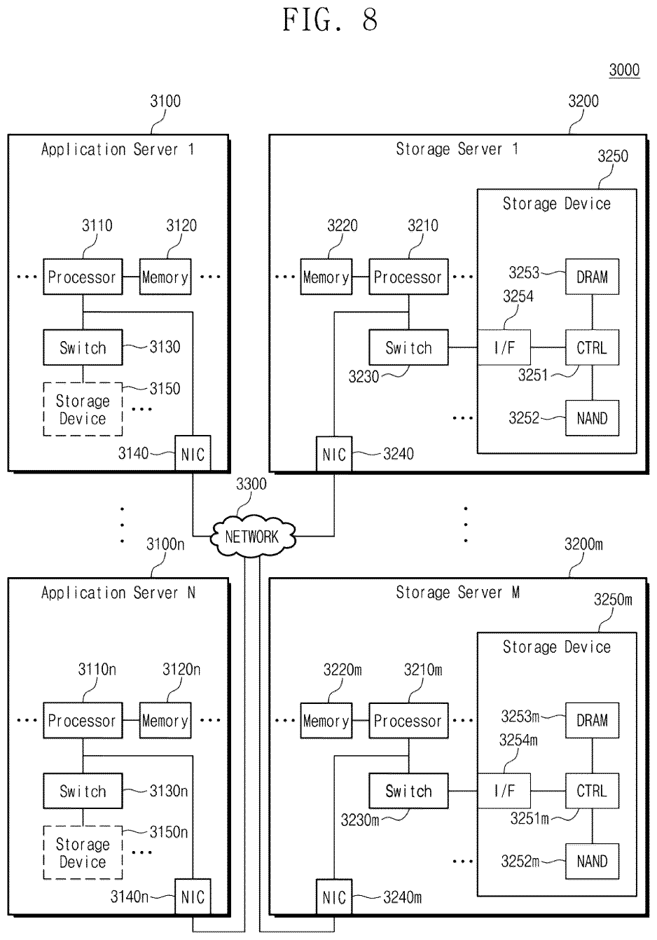

FIG. 8 is a diagram of a data center 3000 to which a memory device is applied, according to an embodiment.

Referring to FIG. 8, the data center 3000 may be a facility that collects various types of pieces of data and provides services and be referred to as a data storage center. The data center 3000 may be a system for operating a search engine and a database, and may be a computing system used by companies, such as banks, or government agencies. The data center 3000 may include application servers 3100 to 3100n and storage servers 3200 to 3200m. The number of application servers 3100 to 3100n and the number of storage servers 3200 to 3200m may be variously selected according to embodiments. In some embodiments, the number of application servers 3100 to 3100n may be different from the number of storage servers 3200 to 3200m, but embodiments are not limited thereto.

The application server 3100 or the storage server 3200 may include at least one of processors 3110 and 3210 and memories 3120 and 3220. An example of the storage server 3200 is described below. The processor 3210 may control all operations of the storage server 3200, access the memory 3220, and execute instructions and/or data loaded in the memory 3220. The memory 3220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some embodiments, the numbers of processors 3210 and memories 3220 included in the storage server 3200 may be variously selected. In an embodiment, the processor 3210 and the memory 3220 may provide a processor-memory pair. In an embodiment, the number of processors 3210 may be different from the number of memories 3220. The processor 3210 may include a single-core processor or a multi-core processor. The above description of the storage server 3200 may be similarly applied to the application server 3100. In some embodiments, the application server 3100 may not include a storage device 3150. The storage server 3200 may include at least one storage device 3250. The number of storage devices 3250 included in the storage server 3200 may be variously selected according to embodiments.

The application servers 3100 to 3100n may communicate with the storage servers 3200 to 3200m through a network 3300. The network 3300 may be implemented by using a fiber channel (FC) or Ethernet. In this case, the FC may be a medium used for relatively high-speed data transmission and use an optical switch with high performance and high availability. The storage servers 3200 to 3200m may be provided as file storages, block storages, or object storages according to an access method of the network 3300.

In an embodiment, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In another embodiment, the network 3300 may be a general network, such as a TCP/IP network. For example, the network 3300 may be implemented according to a protocol, such as FC over Ethernet (FCoE), network attached storage (NAS), and NVMe over Fabrics (NVMe-oF).

Hereinafter, examples of the application server 3100 and the storage server 3200 are described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may obtain data, which is requested by the user or the client to be read, from one of the storage servers 3200 to 3200m through the network 3300. For example, the application server 3100 may be implemented as a web server or a database management system (DBMS).

The application server 3100 may access a memory 3120n or a storage device 3150n, which is included in another application server 3100n, through the network 3300. In some embodiments, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In this case, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

An example of the storage server 3200 is described below. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface protocols and interface schemes, such as at least one of ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC 3240. The switch 3230 may selectively connect the processor 3210 to the storage device 3250 or selectively connect the NIC 3240 to the storage device 3250 via the control of the processor 3210.

In an embodiment, the NIC 3240 may include a network interface card and a network adaptor. The NIC 3240 may be connected to the network 3300 by at least one of a wired interface, a wireless interface, a Bluetooth interface, and an optical interface. The NIC 3240 may include an internal memory, a digital signal processor (DSP), and a host bus interface and be connected to the processor 3210 and/or the switch 3230 using the host bus interface. The host bus interface may be implemented as one of the above-described examples of the interface 3254. In an embodiment, the NIC 3240 may be integrated with at least one of the processor 3210, the switch 3230, and the storage device 3250.

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In this case, the data may be data in which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, when data is read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

The controller 3251 may control operations of the storage device 3250. In an embodiment, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy.

In an embodiment, at least one of the application servers 3100 to 3100n, the storage servers 3200 to 3200m, and the storage devices 3150 to 3150n and 3250 to 3250m included in each server may be the storage device 100 described with reference to FIGS. 1 to 7B. For example, at least one of the application servers 3100 to 3100n, the storage servers 3200 to 3200m, and the storage devices 3150 to 3150n and 3250 to 3250m included in each server may each be accessed by a plurality of hosts, and may directly store data in the nonvolatile memory device 120 based on the operating method described with reference to FIGS. 1 to 7B.

The above description refers to detailed embodiments for carrying out the present disclosure. The present disclosure may include embodiments in which a design is changed simply or which are easily changed, as well as the embodiments described above. In addition, technologies that are easily changed and implemented by using the above embodiments may be included in the present disclosure. While the present disclosure has been described with reference to embodiments described above, it will be apparent to those of ordinary skill in the art that various changes and modifications may be made thereto without departing from the spirit and scope of the present disclosure as set forth in the following claims.

According to an embodiment of the present disclosure, data may be directly stored from a host device to a nonvolatile memory device of a storage device, and power consumption may be reduced by not temporarily storing the data in a buffer.

Although some embodiments of the present disclosure are described above, it will be apparent to those of ordinary skill in the art that various changes and modifications may be made thereto without departing from the spirit and scope of the present disclosure as set forth in the following claims.

What is claimed is:

1. An operation method of a storage device including a nonvolatile memory device and a buffer memory device, the method comprising:
receiving a force unit access (FUA) command from an external host device; and
performing a direct memory access (DMA) operation based on a status of the storage device in response to the FUA command,
wherein the DMA operation comprises one of a first DMA operation and a second DMA operation,
wherein the first DMA operation comprises transferring data from the external host device to the nonvolatile memory device without using the buffer memory device, and
wherein the second DMA operation comprises transferring the data from the external host device to the buffer memory device.

2. The method of claim 1, wherein the performing of the DMA operation comprises:
detecting a cache hit or a cache miss;
based on the cache miss being detected, determining whether the status of the storage device is a busy status or an idle status;
based on determining that the status of the storage device is the idle status, obtaining a comparison result by comparing a size of the data with a page size; and
performing the first DMA operation based on the comparison result.

3. The method of claim 2, wherein the detecting of the cache hit or the cache miss comprises:
based on the cache hit being detected, performing the second DMA operation.

4. The method of claim 2, wherein the determining of the status of the storage device comprises:
based on determining that the status of the storage device is the busy status, performing the second DMA operation.

5. The method of claim 2, wherein the performing of the first DMA operation comprises:
storing the data in a data cache included in a storage controller; and
transferring the data to the nonvolatile memory device based on the size of the data being smaller than the page size.

6. The method of claim 2, wherein the busy status indicates that the storage device is performing a task, and
wherein the idle status indicates that the storage device is not performing the task.

7. A storage device comprising:
a buffer memory device;
a nonvolatile memory device configured to store data received from an external host device; and
a storage controller comprising a one-time direct memory access (DMA) manager,
wherein the storage controller is configured to:
receive a force unit access (FUA) command from the external host device; and
perform a DMA operation based on a status of the storage device in response to the FUA command,
wherein the DMA operation comprises one of a first DMA operation and a second DMA operation,
wherein the first DMA operation comprises transferring the data from the external host device to the nonvolatile memory device without using the buffer memory device, and
wherein the second DMA operation comprises transferring the data from the external host device to the buffer memory device.

8. The storage device of claim 7, wherein the one-time DMA manager is further configured to:
detect a cache hit or a cache miss;
based on the cache miss being determined, determine whether the status of the storage device is a busy status or an idle status;
based on determining that the status of the storage device is the idle status, obtain a comparison result by comparing a size of the data with a page size; and
perform the first DMA operation based on the comparison result.

9. The storage device of claim 8, wherein the one-time DMA manager is further configured to:
based on the cache hit being detected, perform the second DMA operation.

10. The storage device of claim 8, wherein the one-time DMA manager is further configured to:
based on determining that the status of the storage device is the busy status, perform the second DMA operation.

11. The storage device of claim 8, wherein the one-time DMA manager is further configured to:
store the data in a data cache of the storage controller, and
transfer the data to the nonvolatile memory device based on the size of the data being smaller than the page size.

12. The storage device of claim 8, wherein the busy status indicates that the storage device is performing a task, and
wherein the idle status indicates that the storage device is not performing the task.

13. A storage system comprising:
a storage device comprising a storage controller, wherein the storage controller comprises a one-time direct memory access (DMA) manager, a buffer memory device, and a nonvolatile memory device; and
a host device,
wherein the host device is configured to:
transfer a force unit access (FUA) command to the storage device,
wherein the storage device is further configured to:
perform a DMA operation based on a status of the storage device in response to the FUA command,
wherein the DMA operation comprises one of a first DMA operation and a second DMA operation,
wherein the first DMA operation comprises transferring data from the host device to the nonvolatile memory device without using the buffer memory device, and
wherein the second DMA operation comprises transferring the data from the host device to the buffer memory device.

14. The storage system of claim 13, wherein the one-time DMA manager is further configured to:
detect a cache hit or a cache miss;
based on detecting the cache miss, determine whether the status of the storage device is a busy status or an idle status;
based on determining that the status of the storage device is the idle status, obtain a comparison result by comparing a size of the data with a page size; and
perform the first DMA operation based on the comparison result.

15. The storage system of claim 14, wherein the one-time DMA manager is further configured to:
based on detecting the cache hit, perform the second DMA operation.

16. The storage system of claim 14, wherein the one-time DMA manager is further configured to:
based on determining that the status of the storage device is the busy status, perform the second DMA operation.

17. The storage system of claim 15, wherein the one-time DMA manager is further configured to:
store the data in a data cache of the storage controller; and
transfer the data to the nonvolatile memory device based on the size of the data being smaller than the page size.

18. The storage system of claim 14, wherein the busy status indicates that the storage device is performing a task, and
wherein the idle status indicates that the storage device is not performing the task.

19. The storage system of claim 13, wherein the host device comprises a host memory device, and
wherein the host memory device comprises a submission queue and a completion queue.

20. The storage system of claim 19, wherein the host device is further configured to:
allocate the FUA command to the submission queue.
